(19) United States
(12) Patent Application Publication
(10) Pub. No.: US 2019/0010623 A1
(43) Pub. Date: Jan. 10, 2019

(54) FE-NI-P ALLOY MULTI-LAYER STEEL SHEET AND MANUFACTURING METHOD THEREFOR

(71) Applicant: POSCO, Pohang-si, Gyeongsangbuk-do (KR)

(72) Inventors: Dongkyun KIM, Pohang-si, Gyeongsangbuk-do (KR); Minho JO, Pohang-si, Gyeongsangbuk-do (KR); Su-Yong SIN, Pohang-si, Gyeongsangbuk-do (KR); Jong-Tae PARK, Pohang-si, Gyeongsangbuk-do (KR); Yong-Soo KIM, Pohang-si, Gyeongsangbuk-do (KR)

(21) Appl. No.: 16/065,777

(22) PCT Filed: Dec. 20, 2016
(86) PCT No.: PCT/KR2016/014947

§ 371 Date: Jun. 22, 2018

(30) Foreign Application Priority Data
Dec. 24, 2015 (KR) 10-2015-0186247

(51) Int. Cl. C25D 1/04; B32B 15/01; C25D 3/20; C25D 5/10; C25D 3/12

(52) U.S. Cl. CPC C25D 1/04; B32B 15/011; C25D 3/12; C25D 5/10; C25D 3/20

(57) ABSTRACT

The present disclosure relates to an Fe—Ni—P alloy multilayered steel sheet and a method of manufacturing the same.

Provided is an Fe—Ni—P alloy multilayered steel sheet including: an Fe—Ni alloy layer including 30 wt % to 85 wt % of Ni, a remainder Fe, and other inevitable impurities, with respect to 100 wt % as a whole; and an Fe—P alloy layer including 6 wt % to 12 wt % of P, a remainder Fe, and other inevitable impurities, with respect to 100 wt % as a whole, in which the Fe—Ni alloy layer and the Fe—P alloy layer are alternately laminated on each other several times.

### TECHNICAL FIELD

An embodiment of the present disclosure relates to an Fe—Ni—P alloy multilayered steel sheet and a method of manufacturing the same.

### BACKGROUND ART

In general, a steel sheet is manufactured through an iron making process, a steel making process, a hot rolling process, a cold rolling process, and an annealing process. Physical properties that may be implemented are restrained due to restraint of the processes. In detail, in order to pass through the processes, an ingredient element that may be added in addition to iron is limited, and downwardness of the thickness of the steel sheet may be restrained due to limitation of reduction rate control precision. This is because an amorphous structure or a nanocrystalline structure may not be implemented.

In particular, an electric steel sheet is a soft magnetic material including a main constituent element. In order to reduce iron loss, an element that may increase specific resistance, such as silicon, should be added. In addition, it is ideal that the thickness of the steel sheet is reduced, the steel sheet is insulated, is laminated, and is then used, and the amorphous structure or the nanocrystalline structure is implemented. However, in a general steel sheet manufacturing process, there is a limit in implementing the ideal conditions.

An electroforming method is a manufacturing method which may overcome the limit to general manufacturing of a steel sheet. In the electroforming method, after a substrate is electroplated, a plated layer is removed, so that a material is manufactured. Since a general process is not performed, it is possible to add an element that has been restricted previously. Further, a thickness may be easily reduced due to the nature of plating, which is easy to control an electrodeposition amount, and since a melting process and a cooling process are not performed, the amorphous structure or the nanocrystalline structure may be easily implemented. The basic principle of the above-described electroforming method is disclosed in Korean Patent Laid-open Publication No. 2010-0134595.

Meanwhile, when different alloy layers are sequentially laminated on each other to grant complex performance, hot dip plating of various nonferrous metals is used instead of electroplating to form a thick alloy layer. However, in the case of iron, the melting point is so high that there is a problem in applying the hot-dip plating.

To solve the problem, a method is generally used in which a gap between different ferrite alloys is welded and joined using heterogeneous metal or a heterogeneous ingredient. However, when two kinds of alloys are laminated on each other through welding, it is difficult to maintain a sufficient coupling force throughout the entire surface of a panel, and mechanical characteristics may be reduced due to thermal deformation of a welding part. In the case of a magnetic material, magnetic characteristics sensitive to thermal deformation and a stress may be sharply reduced.

An electromagnetic wave shielding material requiring a plurality of bonded metal thin plates may be produced by repeatedly laminating an iron-nickel metal foil and a resin layer as a roundabout method. This is disclosed in Korean Patent Laid-Open Publication No. 2001-0082391.

However, in this case, when press processing for obtaining an actual product is performed, a crack occurs in a laminated metal foil composite due to a difference between deformation rates of the resin layer and the metal layer, and thus it is difficult to use the producing method. Further, when products having the same standard are manufactured, iron loss increases and a magnetic flux density deteriorates due to existence of the resin layer not having magnetic characteristics, as compared to a material formed by laminating only general metal layers.

In addition, when a large amount of P is included, brittleness is high. Thus, a metal thin plate cannot be formed and a multilayered steel sheet cannot be produced, through a general rolling process. A method of manufacturing a multilayered steel sheet having a composite structure of Fe and Fe—P using Fe powder and Fe—P powder is disclosed in Korean Patent No. 10-1504131. However, in the above case, a complex process is required in which a formed body produced through preliminary sintering is hot rolled again and is finally heat treated. Further, in the heat treatment process, since formation of Fe₂P precipitate phases and Fe₃P precipitate phases, which simultaneously reduce magnetic characteristics and mechanical characteristics of Fe—P, cannot be prevented, there is a limit in securing the magnetic characteristics and the mechanical characteristics.

### DISCLOSURE

### Technical Problem

An embodiment of the present disclosure provides a Fe—Ni—P alloy multilayered steel sheet and a method of manufacturing the same.

### Technical Solution

An Fe—Ni—P alloy multilayered steel sheet according to an embodiment of the present disclosure may include: an Fe—Ni alloy layer including 30 wt % to 85 wt % of Ni, a remainder Fe, and other inevitable impurities, with respect to 100 wt % as a whole; and an Fe—P alloy layer including 6 wt % to 12 wt % of P, a remainder Fe, and other inevitable impurities, with respect to 100 wt % as a whole, in which the Fe—Ni alloy layer and the Fe—P alloy layer are alternately laminated on each other several times.

The Fe—P alloy layer may have an amorphous base structure, and may include, with respect to the total volume 100% of microstructures of the alloy layer, less than 5% of an Fe₂P phase, an Fe₃P phase, or a combination thereof. The Fe—P alloy layer may include less than 50% of crystal grains having a grain size of 10 nm or less, with respect to the total volume 100% of microstructures of the Fe—P alloy layer.

The Fe—Ni alloy layer may have an amorphous base structure, and may include less than 50% of crystal grains having a grain size of 10 nm or less, with respect to the total volume 100% of microstructures of the Fe—Ni alloy layer.

A method of manufacturing an Fe—Ni—P alloy multilayered steel sheet according to another embodiment of the present disclosure may include:

preparing an electroforming substrate; electrodepositing an Fe—Ni alloy layer on a surface of the electroforming substrate; electrodepositing an Fe—P alloy layer on a surface of the Fe—Ni alloy layer; laminating the two kinds of alloy layers in multiple layers by alternately repeating the electrodepositing of the Fe—Ni alloy layer and the electrodepositing of the Fe—P alloy layer; and peeling, from the electroforming substrate, a multilayered steel sheet in which the two kinds of alloy layers are alternately laminated on each other.

The electrodepositing of the Fe—Ni alloy layer on the surface of the electroforming substrate may include: preparing a plating solution including an iron compound and a nickel compound; applying a current to the plating solution; and electrodepositing the Fe—Ni alloy layer on the surface of the electroforming substrate by reducing iron ions and nickel ions by the applied current.

In the preparing of the plating solution including the iron compound and the nickel compound, the iron compound may be FeSO₄, Fe(SO₃NH₂)₂, FeCl₂, Fe powder or a combination thereof, and a concentration of the iron compound in the plating solution may range from 0.5 M to 4.0 M.

In the preparing of the plating solution including the iron compound and the nickel compound, the nickel compound may be NiSO₄, NiCl₂, or a combination thereof, and a concentration of the nickel compound in the plating solution may range from 0.1 M to 3.0 M.

In the preparing of the plating solution including the iron compound and the nickel compound, the plating solution may include an addition agent, and a concentration of the addition agent in the plating solution may range from 0.001 M to 0.1 M. Further, the addition agent may be glycolic acid, saccharin, beta-alanine, DL-alanine, succinic acid, or a combination thereof.

A pH of the plating solution may range from 1 to 4, and a temperature of the plating solution may range from 30° C. to 100° C.

In the applying of the current to the plating solution, the current may be a direct current or a pulse current, and a current density of the current may range from 1 A/dm² to 100 A/dm².

In the electrodepositing of the Fe—Ni alloy layer on the surface of the electroforming substrate by reducing iron ions and nickel ions by the applied current, a thickness of the Fe—Ni alloy layer electrodeposited on the surface of the electroforming substrate may range from 0.1 μm to 1000 μm.

Further, the Fe—Ni alloy layer electrodeposited on the surface of the electroforming substrate may include, with respect to 100 wt % as a whole, 30 wt % to 85 wt % of Ni, a remainder Fe, and other inevitable impurities.

The electrodepositing of the Fe—P alloy layer on the surface of the Fe—Ni alloy layer may include: preparing a plating solution including an iron compound and a phosphorus compound; applying a current to the plating solution; and electrodepositing the Fe—P alloy layer on the surface of the Fe—Ni alloy layer by reducing iron ions and phosphorus ions by the applied current.

In the preparing of the plating solution including the iron compound and the phosphorus compound, the iron compound may be FeSO₄, Fe(SO₃NH₂)₂, FeCl₂, Fe powder, or a combination thereof, and a concentration of the iron compound in the plating solution may range from 0.5 M to 4.0 M.

Further, the phosphorus compound may be NaH₂PO₂, H₃PO₂, H₃PO₃, or a combination thereof, and a concentration of the phosphorus compound in the plating solution may range from 0.01 M to 3.0 M.

In the preparing of the plating solution including the iron compound and the phosphorus compound, the plating solution may include an addition agent, and a concentration of the addition agent in the plating solution may range from 0.001 M to 0.1 M. Further, the addition agent may be glycolic acid, saccharin, beta-alanine, DL-alanine, succinic acid, or a combination thereof.

A pH of the plating solution may range from 1 to 4, and a temperature of the plating solution may range from 30° C. to 100° C.

In the applying of the current to the plating solution, the current may be a direct current or a pulse current, and a current density of the current may range from 1 A/dm² to 100 A/dm².

In the electrodepositing of the Fe—P alloy layer on the surface of the Fe—Ni alloy layer by reducing iron ions and phosphorus ions by the applied current, a thickness of the Fe—P alloy layer electrodeposited on the surface of the Fe—Ni alloy layer may range from 0.1 μm to 1000 μm. Further, the Fe—P alloy layer electrodeposited on the surface of the Fe—Ni alloy layer may include 6 wt % to 12 wt % of P, a remainder Fe, and other inevitable impurities, with respect to 100 wt % as a whole.

In the preparing of the electroforming substrate, the electroforming substrate may include stainless, titanium, and a combination thereof

### Advantageous Effects

In the Fe—Ni—P alloy multilayered steel sheet according to an embodiment of the present disclosure, the alloy layers having different ingredients may be laminated on each other without a separate bonding process or a separate bonding layer. Further, the alloy layers may be repeatedly laminated on each other several times to provide a multilayered steel sheet.

From this, a steel sheet may be provided which simultaneously has excellent mechanical characteristics and excellent magnetic characteristics due to the Fe—Ni alloy layer having excellent mechanical properties and high permeability and the Fe—P alloy layer having a high saturation magnetic flux density.

### DESCRIPTION OF THE DRAWINGS

FIG. 1 is a flowchart illustrating a method of manufacturing an ultra-thin multilayered steel sheet according to an embodiment of the present disclosure.

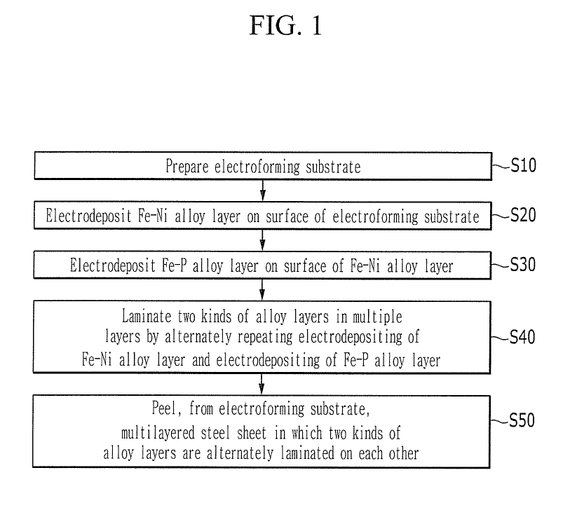

FIG. 2 illustrates an Fe—Ni—P alloy multilayered steel sheet according to the embodiment of the present disclosure.

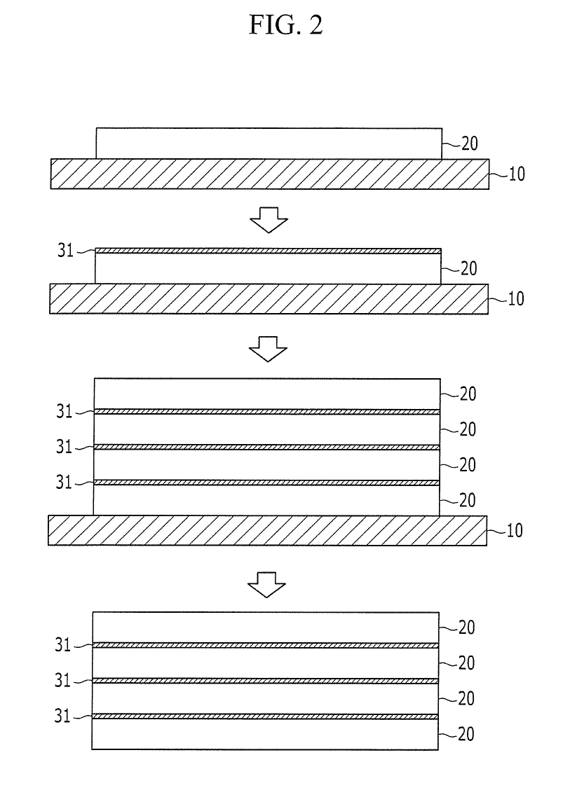

### MODE FOR INVENTION

The advantages and features of the present disclosure, and the manner of achieving them will become apparent with reference to embodiments described in detail below together with the accompanying drawings. However, the present disclosure is not limited to the following embodiments, and may be implemented in other various forms. Further, the present embodiments are merely provided to make the present disclosure complete, and completely inform the scope of the present disclosure to those skilled in the art to which the present disclosure pertains. Furthermore, the present disclosure is only defined by the appended claims. The same components are designated by the same reference numerals throughout the specification.

Thus, in some embodiments, widely known technologies are not specifically described to avoid ambiguous interpretation of the present disclosure. Unless otherwise defined, all terms (including technical terms and scientific terms) used in the specification may be used to be commonly understood by those skilled in the art to which the present disclosure pertains. When it is described throughout the specification that a first component “includes” a second component, this means that a third component is not excluded but is further included unless specifically otherwise described. Further, a singular form includes a plural form unless otherwise mentioned in a phrase.

An Fe—Ni—P alloy multilayered steel sheet according to an embodiment of the present disclosure may include: an Fe—Ni alloy layer including, with respect to 100 wt % as a whole, 30 wt % to 85 wt % of Ni, a remainder Fe, and other inevitable impurities; and an Fe—P alloy layer including, with respect to 100 wt % as a whole, 6 wt % to 12 wt % of P, a remainder Fe, and other inevitable impurities.

The Fe—Ni—P alloy multilayered steel sheet may be provided in which the Fe—Ni alloy layer and the Fe—P alloy layer are alternately laminated on each other several times.

In more detail, the Fe—Ni alloy layer and the Fe—P alloy layer may be alternately laminated on each other one time to ten times.

In this case, the multilayered steel sheet in which the two kinds of alloy layers are alternately laminated on each other several times does not include a separate bonding layer between the two kinds of alloy layers.

Further, the Fe—P alloy layer may have an amorphous base structure, and may include, with respect to the total volume 100% of microstructures of the alloy layer, less than 5% of an Fe₂P phase, an Fe₃P phase, or a combination thereof.

In more detail, the above-described precipitate phases are reduced to the range, so that magnetic characteristics may be improved and iron loss may be reduced.

In addition, the Fe—P alloy layer and the Fe—Ni alloy layer may include less than 50% of crystal grains having a grain size of 10 nm or less with respect to the total volume 100% of microstructures.

In more detail, the Fe—P alloy layer and the Fe—Ni alloy layer may have a form in which crystal grains mixedly exist in the amorphous structure. From this, a saturation magnetic flux density may be improved as compared to an amorphous single phase. When the crystal grains having the size range mixedly exist, the improving effect may be maximized.

In addition, in the specification, the grain size means an average diameter of a spherical substance existing in a measurement unit. When the substance has a non-spherical shape, the grain size means the diameter of a sphere, which is calculated in a state in which the non-spherical substance is approximated to a spherical shape.

Further, the grain size of the crystal grains disclosed in the specification is a result calculated by substituting, into Scherrer's equation, a diffraction angle and the intensity of a diffraction beam of data obtained by using the XRD analysis method.

Hereinafter, the reason why compositions of the alloy layer are limited will be described in an embodiment of the present disclosure.

First, Ni may serve to improve processability by reducing hardness. In more detail, when the content of Ni exceeds 30 wt %, the hardness is reduced, so that an occurrence rate of cracks occurring in an edge portion during a punching process may be reduced. A crack occurrence reducing effect can be identified through an initial crack occurrence angle test during bending deformation according to the embodiment of the present disclosure. However, considering that nickel is an expensive raw material, when the content of nickel exceeds 85 wt %, changes in characteristics depending on the content of nickel are not high, and thus it is preferable that 85 wt % or less of nickel is added.

Further, since P serves to reduce iron loss by increasing specific resistance, the specific resistance may increase as the amount of added P increases. However, when more than 12 wt % of P is added, the processability may deteriorate. On the other hand, when less than 6 wt % of P is added, the amorphous phase is not formed, and thus an additional specific resistance increasing effect may not be acquired.

A method of manufacturing an Fe—Ni—P alloy multilayered steel sheet according to another embodiment of the present disclosure may include: preparing an electroforming substrate; electrodepositing an Fe—Ni alloy layer on a surface of the electroforming substrate; electrodepositing an Fe—P alloy layer on a surface of the Fe—Ni alloy layer; laminating the two kinds of alloy layers in multiple layers by alternately repeating the electrodepositing of the Fe—Ni alloy layer and the electrodepositing of the Fe—P alloy layer; and peeling, from the electroforming substrate, a multilayered steel sheet in which the two kinds of alloy layers are alternately laminated on each other.

First, in the preparing of the electroforming substrate, the electroforming substrate may include stainless, titanium, or a combination thereof. However, in addition, since all materials having acid resistance and having an oxide film may be used, the present disclosure is not limited to the materials.

In more detail, the surface of the electroforming substrate may be a material which may have conductivity and of which a surface may be separated from an electrodeposit after the electrodepositing. In more detail, the surface of the electroforming substrate may be a material having less thermal deformation at 100° C. or less and acid resistance against acidic electrolyte. Further, the surface of the electroforming substrate may be a material which has proper adhesiveness with the electrodeposit to facilitate the electroforming, and has excellent wear resistance by which the electroforming substance may withstand the repeated electrodeposition and the peeling.

Thereafter, the electrodepositing of the Fe—Ni alloy layer on the surface of the electroforming substance may be performed.

In more detail, the electrodepositing of the Fe—Ni alloy layer on the surface of the electroforming substrate may include: preparing a plating solution including an iron compound and a nickel compound; applying a current to the plating solution; and electrodepositing the Fe—Ni alloy layer on the surface of the electroforming substrate by reducing iron ions and nickel ions by the applied current.

First, in the preparing of the plating solution including an iron compound and a nickel compound, although the iron compound may include FeSO₄, Fe(SO₃NH₂)₂, FeCl₂, Fe powder, or a combination thereof, the present disclosure is not limited thereto.

In this case, a concentration of the iron compound in the plating solution may be 0.5 M to 4.0 M.

When the concentration of the iron compound is in the above range, it is easy to form the Fe—Ni alloy layer.

In addition, although the nickel compound may be NiSO4, NiCl2 or a combination thereof, the present disclosure is not limited thereto.

In this case, a concentration of the nickel compound in the plating solution may be 0.1 M to 3.0 M.

When the concentration of the nickel compound is in the above range, it is easy to form the Fe—Ni alloy layer.

Further, the plating solution may include an addition agent, and a concentration of the addition agent in the plating solution may be 0.001 M to 0.1 M.

In this case, the addition agent may include glycolic acid, saccharin, beta-alanine, DL-alanine, succinic acid, or a combination thereof. However, the present disclosure is not limited thereto.

In more detail, when the addition agent having the concentration is further included, it is further easy to form a plated layer.

A pH of the plating solution may range from 1 to 4, and the temperature of the plating solution may range from 30° C. to 100° C.

In more detail, the pH of the plating solution may be adjusted to the range by one or more acids and/or one or more bases being added.

When the pH and the temperature of the plating solution are in the above ranges, it may be easy to form the plated layer.

Thereafter, the applying of the current to the plating solution may be performed.

In this case, the current may be a direct current or a pulse current, and a current density of the current may be 1 A/dm² to 100 A/dm².

The electrodepositing of the Fe—Ni alloy layer on the surface of the electroforming substrate by reducing the iron ions and the nickel ions by the applied current may be performed.

The thickness of the Fe—Ni alloy layer electrodeposited on the surface of the electroforming substrate may be 0.1 μm to 1000 μm.

In addition, the Fe—Ni alloy layer electrodeposited on the surface of the electroforming substrate may include 30 wt % to 85 wt % of Ni, a remainder Fe, and other inevitable impurities, with respect to 100 wt % as a whole. The reason why the compositions of the Fe—Ni alloy layer are limited is the same as that described above, and thus will be omitted.

Thereafter, the electrodepositing of the Fe—P alloy layer on the surface of the Fe—Ni alloy layer may be performed.

In this case, the electrodepositing of the Fe—P alloy layer on the surface of the Fe—Ni alloy layer may include: preparing a plating solution including an iron compound and a phosphorus compound; applying a current to the plating solution; and electrodepositing the Fe—P alloy layer on the surface of the Fe—Ni alloy layer by reducing iron ions and phosphorus ions by the applied current.

In the preparing of the plating solution including the iron compound and the phosphorus compound, the iron compound may be FeSO₄, Fe(SO₃NH₂)₂, FeCl₂, Fe powder, or a combination thereof, and a concentration of the iron compound in the plating solution may be 0.5 M to 4.0 M.

Further, the phosphorus compound may be NaH₂PO₂, H₃PO₂, H₃PO₃, or a combination thereof, and a concentration of the phosphorus compound in the plating solution may be 0.01 M to 3.0 M.

In addition, the plating solution may include an addition agent, and a concentration of the addition agent in the plating solution may be 0.001 M to 0.1 M.

The addition agent may be glycolic acid, saccharin, beta-alanine, DL-alanine, succinic acid, or a combination thereof. However, the present disclosure is not limited thereto.

A pH of the plating solution may range from 1 to 4, and the temperature of the plating solution may range from 30° C. to 100°.

Thereafter, the applying of the current to the plating solution may be performed.

In this case, the current may be a direct current or a pulse current, and a current density of the current may be 1 A/dm² to 100 A/dm².

The electrodepositing of the Fe—P alloy layer on the surface of the Fe—Ni alloy layer by applying the iron ions and the phosphorus ions by the applied current.

In this case, the thickness of the Fe—P alloy layer electrodeposited on the surface of the Fe—Ni alloy layer may be 0.1 μm to 1000 μm.

In addition, the Fe—P alloy layer electrodeposited on the surface of the Fe—Ni alloy layer may include 6 wt % to 12 wt % of P, a remainder Fe, and inevitable impurities, with respect to 100 wt % as a whole.

Thereafter, the laminating of the two kinds of alloy layers in multiple layers by alternately repeating the electrodepositing of the Fe—Ni alloy layer and the electrodepositing of the Fe—P alloy layer may be performed.

In more detail, the above-described electrodepositing of the Fe—Ni alloy layer and the above-described electrodepositing of the Fe—P alloy layer may be alternately performed several times. In more detail, the two kinds of alloy layers may be alternately laminated on each other in multiple layers several times.

In more detail, in the laminating of the two kinds of alloy layers in multiple layers by alternately repeating the electrodepositing of the Fe—Ni alloy layer and the electrodepositing of the Fe—P alloy layer,

The Fe—Ni alloy layer and the Fe—P alloy layer may be alternately laminated in multiple layers one time to ten times.

Finally, the peeling of, from the electroforming substrate, the multilayered steel sheet in which the two kinds of alloy layers are alternately laminated on each other may be performed.

According to the above description, the two kinds of alloy layers are alternately laminated on the electroforming substrate in multiple layers. Accordingly, the Fe—Ni—P alloy multilayered steel sheet may be acquired by the peeling of, from the electroforming substance, the multilayered steel sheet in which the two kinds of alloy layers are alternately laminated on each other.

In more detail, the steel sheet having a desired thickness may be acquired by laminating the two kinds of alloy layers in a thin plate several times through an electroforming process.

Hereinafter, the present disclosure may be described in detail through embodiments. The following embodiments are merely intended to describe the present disclosure, and the contents of the present disclosure are not limited by the following embodiments.

### EMBODIMENT

After an electroforming steel sheet is prepared, a current is applied to a plating solution including an iron compound and a nickel compound.

A Fe—Ni alloy layer including 36 wt % of Ni, a remainder Fe, and inevitable impurities with respect to 100 wt % as a whole is electrodeposited on a surface of the electroforming steel sheet by the current.

Thereafter, in a state in which the steel sheet on which the Fe—Ni alloy layer is electrodeposited is injected into the plating solution including an iron compound and a phosphorus compound, the current is applied to the plating solution.

A Fe—P alloy layer including 11 wt % of P, a remainder Fe, and inevitable impurities with respect of 100 wt % as a whole is electrodeposited on a surface of the Fe—Ni alloy layer by the current.

Thereafter, the Fe—Ni alloy layer and the Fe—P alloy layer are alternately electrodeposited several times.

Finally, the multilayered steel sheet in which the two kinds of alloy layers are alternately laminated on each other is acquired by peeling, from the electroforming substrate, the multilayered steel sheet in which the two kinds of alloy layers are alternately laminated on each other.

### Comparative Example 1

Two kinds of powders including a powder including 10.5 wt % of P, a remainder Fe, and inevitable impurities and an Fe pure iron powder are used.

In more detail, the two kinds of powders are mixed with each other, and are sintered at 700° C. or more.

Thereafter, the sintered powders are hot rolled to produce a steel sheet including two kinds of alloys.

### Comparative Example 2

A plurality of thin plates, each of which includes 36 wt % of Ni, a remainder Fe, and inevitable impurities with respect to 100 wt % as a whole, are prepared.

Thereafter, the thin plates are laminated on each other using adhesive resin, so that a multilayered steel sheet, in which a plurality of metal thin plates are coupled to each other, are produced.

TABLE 1

| | Initial crack generated | 50 Hz, 1.5 T iron loss |
|---|---|---|
| | bending angle | [W/kg] |
| Comparative Example 1 | 7.4 degrees | 10.5 |
| Comparative Example 2 | 15 degrees | 6.23 |
| Embodiment | 35 degrees | 2.12 |

As represented in Table 1, crack generation degrees obtained when the multilayered steel sheet is bent according to the manufacturing methods are compared with each other using the embodiment and the comparative examples.

In more detail, the bending angle is obtained by measuring an angle, at which a crack is generated initially, by bending a material having a size of 1 mm×60 mm×60 mm in a zero-degree horizontal state.

As a result, as represented by Table 1, in the case of the embodiment in which a plurality of alloy layers are laminated on each other using an electroforming process, it can be identified that the amount of cracks generated during processing is significantly low as compared to the comparative examples. This is because a difference between deformation rates of the alloy layers is small due to strong chemical bonding.

On the other hand, it can be identified that in the case of the comparative examples 1 and 2 using sintering or resin, a crack generated angle is very low and the amount of iron loss is also large, as compared to the embodiment.

In more detail, it can be identified that in the case of the comparative example 2 using the Fe—Ni alloy layer, mechanical properties (the bending angle) are excellent, as compared to the comparative example 1 not using a nickel-based alloy layer.

However, it can be identified that in the case of the comparative example 1 in which the Fe—P alloy layer is sintered to produce the multilayered steel sheet, since the nickel-based alloy layer is not used, the mechanical properties are bad as compared to the comparative example 2, and the amount of the iron loss is large as compared to the comparative example 2 not including P.

In contrast, in the case of the embodiment, the iron loss is low, and at the same time, the mechanical properties are excellent as compared to the comparative examples 1 and 2.

Although the embodiments of the present disclosure have been described above with reference to the accompanying drawings, it may be understood by those skilled in the art to which the present disclosure pertains that the present disclosure may be implemented in other detailed forms without changing the technical spirit or the essential feature of the present disclosure.

Therefore, it should be understood that the above-described embodiments are not restrictive but illustrative in all aspects. The scope of the present disclosure is defined not by the detailed description but by the appended claims, and it should be interpreted that all changes and modifications that are derived from the meaning and scope of the appended claims, and the equivalent concepts thereof are included in the scope of the present disclosure.

### DESCRIPTION OF SYMBOLS

10: Electroforming substrate
20: Fe—Ni alloy layer
31: Fe—P alloy layer

1. An Fe—Ni—P alloy multilayered steel sheet comprising:
an Fe—Ni alloy layer including 30 wt % to 85 wt % of Ni, a remainder Fe, and other inevitable impurities, with respect to 100 wt % as a whole; and
an Fe—P alloy layer including 6 wt % to 12 wt % of P, a remainder Fe, and other inevitable impurities, with respect to 100 wt % as a whole,
wherein the Fe—Ni alloy layer and the Fe—P alloy layer are alternately laminated on each other several times.

2. The Fe—Ni—P alloy multilayered steel sheet of claim 1, wherein the Fe—P alloy layer has an amorphous base structure, and includes, with respect to the total volume 100% of microstructures of the alloy layer, less than 5% of an Fe₂P phase, an Fe₃P phase, or a combination thereof.

3. The Fe—Ni—P alloy multilayered steel sheet of claim 2, wherein the Fe—P alloy layer includes less than 50% of crystal grains having a grain size of 10 nm or less, with respect to the total volume 100% of microstructures of the Fe—P alloy layer.

4. The Fe—Ni—P alloy multilayered steel sheet of claim 3, wherein the Fe—Ni alloy layer has an amorphous base structure, and includes less than 50% of crystal grains having a grain size of 10 nm or less, with respect to the total volume 100% of microstructures of the Fe—Ni alloy layer.

5. The Fe—Ni—P alloy multilayered steel sheet of claim 1, wherein the Fe—Ni alloy layer and the Fe—P alloy layer are alternately laminated on each other one time to ten times.

6. A method of manufacturing an Fe—Ni—P alloy multilayered steel sheet, the method comprising:
preparing an electroforming substrate;
electrodepositing an Fe—Ni alloy layer on a surface of the electroforming substrate;
electrodepositing an Fe—P alloy layer on a surface of the Fe—Ni alloy layer;
laminating the two kinds of alloy layers in multiple layers by alternately repeating the electrodepositing of the Fe—Ni alloy layer and the electrodepositing of the Fe—P alloy layer; and
peeling, from the electroforming substrate, a multilayered steel sheet in which the two kinds of alloy layers are alternately laminated on each other.

7. The method of claim 6, wherein in the laminating of the two kinds of alloy layers in multiple layers by alternately repeating the electrodepositing of the Fe—Ni alloy layer and the electrodepositing of the Fe—P alloy layer, the Fe—Ni alloy layer and the Fe—P alloy layer are alternately laminated on each other one time to ten times.

8. The method of claim 6, wherein the electrodepositing of the Fe—Ni alloy layer on the surface of the electroforming substrate includes:
preparing a plating solution including an iron compound and a nickel compound;
applying a current to the plating solution; and
electrodepositing the Fe—Ni alloy layer on the surface of the electroforming substrate by reducing iron ions and nickel ions by the applied current.

9. The method of claim 33, wherein the iron compound is FeSO₄, Fe(SO₃NH₂)₂, FeCl₂, Fe powder or a combination thereof.

10. The method of claim 9, wherein a concentration of the iron compound in the plating solution ranges from 0.5 M to 4.0 M.

11. The method of claim 33, wherein in the preparing of the plating solution including the iron compound and the nickel compound, the nickel compound is NiSO₄, NiCl₂, or a combination thereof.

12. The method of claim 11, wherein in the preparing of the plating solution including the iron compound and the nickel compound, a concentration of the nickel compound in the plating solution ranges from 0.1 M to 3.0 M.

13. The method of claim 33, wherein the plating solution includes an addition agent, and a concentration of the addition agent in the plating solution ranges from 0.001 M to 0.1 M.

14. (canceled)

15. (canceled)

16. (canceled)

17. (canceled)

18. The method of claim 33, wherein in the electrodepositing of the Fe—Ni alloy layer on the surface of the electroforming substrate by reducing iron ions and nickel ions by the applied current, a thickness of the Fe—Ni alloy layer electrodeposited on the surface of the electroforming substrate ranges from 0.1 μm to 1000 μm.

19. (canceled)

20. (canceled)

21. (canceled)

22. (canceled)

23. The method of claim 33, wherein in the preparing of the plating solution including the iron compound and the phosphorus compound, the phosphorus compound is NaH₂PO₂, H₃PO₂, H₃PO₃, or a combination thereof.

24. The method of claim 23, wherein in the preparing of the plating solution including the iron compound and the phosphorus compound, a concentration of the phosphorus compound in the plating solution ranges from 0.01 M to 3.0 M.

25. (canceled)

26. (canceled)

27. (canceled)

28. (canceled)

29. (canceled)

30. The method of claim 33, wherein in the electrodepositing of the Fe—P alloy layer on the surface of the Fe—Ni alloy layer by reducing iron ions and phosphorus ions by the applied current, a thickness of the Fe—P alloy layer electrodeposited on the surface of the Fe—Ni alloy layer ranges from 0.1 μm to 1000 μm.

31. (canceled)

32. The method of claim 33, wherein in the preparing of the electroforming substrate, the electroforming substrate includes stainless, titanium, or a combination thereof.

33. The method of claim 8, wherein the electrodepositing of the Fe—P alloy layer on the surface of the Fe—Ni alloy layer includes:
preparing a plating solution including an iron compound and a phosphorus compound;
applying a current to the plating solution; and
electrodepositing the Fe—P alloy layer on the surface of the Fe—Ni alloy layer by reducing iron ions and phosphorus ions by the applied current.
